(19) United States
(12) Patent Application Publication
(10) Pub. No.: US 2019/0118398 A1
(43) Pub. Date: Apr. 25, 2019

(54) Axe

(71) Applicant: Heikki Kärnä, Västerskog (FI)

(72) Inventor: Heikki Kärnä, Västerskog (FI)

(21) Appl. No.: 16/094,675

(22) PCT Filed: Apr. 18, 2017
(86) PCT No.: PCT/FI2017/050291

§ 371 Date: Oct. 18, 2018

(30) Foreign Application Priority Data
Apr. 18, 2016 (FI) 20165334

(51) Int. Cl. B26B 23/00; B25F 1/00; B25G 1/04

(52) U.S. Cl. CPC B26B 23/00; B25G 1/04; B25F 1/006

(57) ABSTRACT

Described is an axe comprising an axe head and a handle having one end portion to which the axe head is arranged. The axe head comprises a handle attaching structure and blade means attached to the handle attaching structure. The blade means are configured to provide a chopping blade and a splitting blade.

### FIELD

The invention relates to an axe as defined in the preamble of independent claim 1.

A number of various types of axes are known in the art. Chopping axes are used for cutting logs transversely to the grain and for delimbing. Chopping axes have normally an axe head that is symmetrical with respect to a symmetry plane. Splitting axes are used for splitting wood along the grain. Conventional splitting axes have normally an axe head that is symmetrical with respect to a symmetry plane in the same manner as the axe head of a chopping axe. The axe head of a splitting axe is however normally thicker than the axe head of a chopping axe to assist in the splitting of wood along the grain. A developed version of a splitting axe is the asymmetric axe that is configured to turn after impact and consequently to facilitate splitting wood. An example of an asymmetric axe is presented in publication WO 02/062539.

For prior art, reference is also made to publications U.S. Pat. Nos. 1,504,644, 1,189,005, 738,869, and EP 0 469 707.

### OBJECTIVE

The object is to provide an axe that is capable of function both as an effective chopping axe and as an effective splitting axe.

### SHORT DESCRIPTION

The axe is characterized by the definitions of independent claim 1.

Preferred embodiments of the axe are defined in the dependent claims.

The invention is based on that the blade means of the axe head of the axe is configured to provide both a chopping blade so that the axe can function as an effective chopping axe and a splitting blade so that the axe can function as an effective splitting axe. An advantage of this is that in case the axe is in the form of a small-size camping axe, the axe can firstly be used for effectively cutting down a tree by using the chopping blade and the axe can subsequently be used for effectively splitting the tree into pieces of wood suitable for a campfire by using the splitting blade. Another advantage is that a user of the axe can use one axe for both effective chopping and splitting.

In a first embodiment of the axe, said blade means of the axe head comprises a first blade member that is pivotally connected to a handle attaching structure of the axe head by means of a pivot member so that the first blade member can pivot, i.e. be selectively pivoted, about a pivot axis with respect to the handle attaching structure between a first position to provide said chopping blade and a second position to provide said splitting blade.

In a second embodiment and in a third embodiment of the axe, said blade means comprises a first blade member configured to form the splitting blade and a second blade member configured to form the chopping blade.

### LIST OF FIGURES

In the following the axe will described in more detail by referring to the figures, of which

FIG. 1 shows as illustrated from one end a first embodiment of the axe having a first blade member set with respect to a handle attaching structure into a first position to provide a chopping blade,

FIG. 2 shows as illustrated from one end the axe shown in FIG. 1 having the first blade member set with respect to the handle attaching structure into a second position to provide a splitting blade,

FIG. 3 shows a function principle of the axe shown in FIG. 1,

FIG. 4 shows in partly cut-view the axe head of the axe shown in FIG. 1, and

FIG. 5 shows the axe illustrated in FIG. 1 as seen from one side,

FIG. 6 shows as illustrated from one end a second embodiment of the axe,

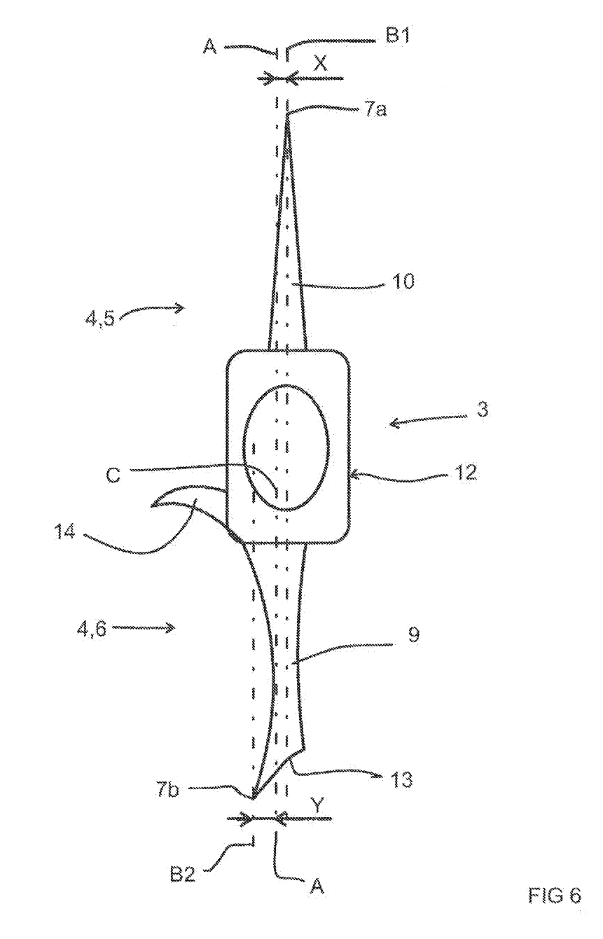

FIG. 7 shows a function principle of the axe shown in FIG. 6,

FIG. 8 shows the axe illustrated in FIG. 5 as seen from one side,

FIG. 9 shows as illustrated from one end a third embodiment of the axe,

FIG. 10 shows a function principle of the axe shown in FIG. 9,

FIG. 11 shows the axe that is illustrated from one end in FIG. 9,

FIG. 12 shows as illustrated from one end a fourth embodiment of the axe,

FIG. 13 shows as illustrated from one end a fifth embodiment of the axe,

FIG. 14 shows the axe that is illustrated from one end in FIG. 13,

FIG. 15 shows as illustrated from one end a sixth embodiment of the axe having a first blade member set with respect to a handle attaching structure into a first position to provide a chopping blade,

FIG. 16 shows as illustrated from one end the axe shown in FIG. 15 having the first blade member set with respect to the handle attaching structure into a second position to provide a splitting blade,

FIG. 17 shows the axe shown in FIGS. 15 and 16 as seen from one side in a statee, there the first blade member is detached.

### DETAILED DESCRIPTION OF THE INVENTION

The invention relates to an axe (not marked with a reference numeral) comprising an axe head 1 and a handle 2 to which one end portion the axe head 1 is arranged.

The axe head 1 comprises a handle attaching structure 3.

The axe head 1 comprises blade means 4 attached to the handle attaching structure 3 and configured to provide a chopping blade 5 and a splitting blade 6.

The center of gravity C of the axe head 1 lies in a center-of-gravity plane A; A1; A2 of the axe head 1. The center-of-gravity plane of the axe head 1 is in the figures marked with one of the reference signs A, A1, or A2 for clarity reasons, because the position of the center-of-gravity plane of the axe head 1 can be shifted in the first embodiment of the axe.

The chopping blade 5 of the axe head 1 has a cutting edge 7a.

The center-of-gravity plane A; A1; A2 of the axe head 1 is parallel with a first blade plane B1 on which the cutting edge 7a of the chopping blade 5 of the axe head 1 is located.

The splitting blade 6 of the axe head 1 has a cutting edge 7b.

The center-of-gravity plane A; Al; A2 of the axe head 1 is parallel with a second blade plane B2 on which the cutting edge 7b of the splitting blade 6 of the axe head 1 is located.

The center-of-gravity plane A; A2 of the axe head 1 is located at a first distance Y from the second blade plane B2.

The cutting edge 7b of the splitting blade 6 of the axe head 1 and the center of gravity C of the axe head 1 are arranged to cooperate when the cutting edge 7b of the splitting blade 6 of the axe head 1 hits a piece of wood 15 and the cutting edge 7b of the splitting blade 6 of the axe head 1 penetrates into the piece of wood 15 such that at least some of the impact force of the axe head 1 is converted into a rotational motion of the axe head 1 and a motion of the axe head 1 in a curvilinear trajectory D.

The center-of-gravity plane A; A1 of the axe head 1 can be located at a second distance X from the first blade plane B1 on which the cutting edge 7a of the chopping blade 5 of the axe head 1 is located so that the first distance Y is longer than the second distance X.

The handle 2 can be foldable and/or telescopic or be a conventional rigid axe handle. A foldable and/or telescopic handle facilitates transportation and storage of the axe.

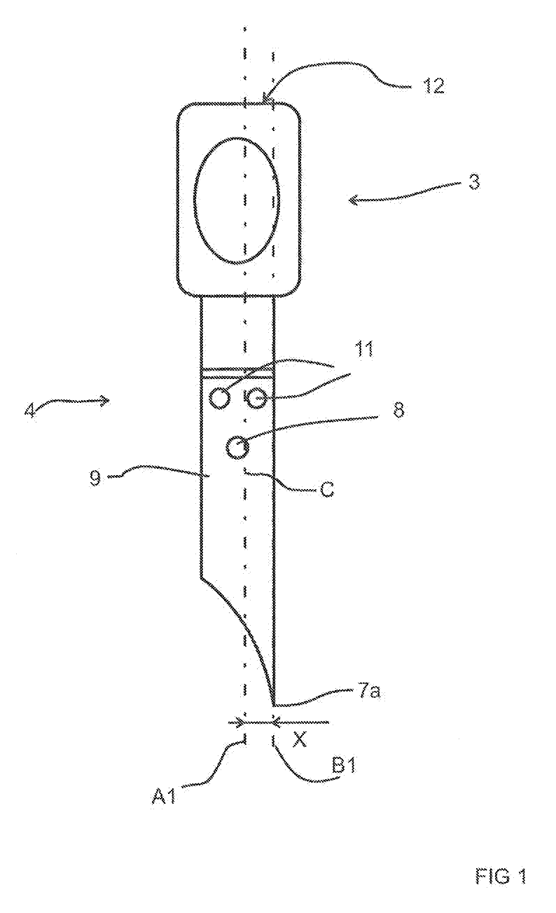

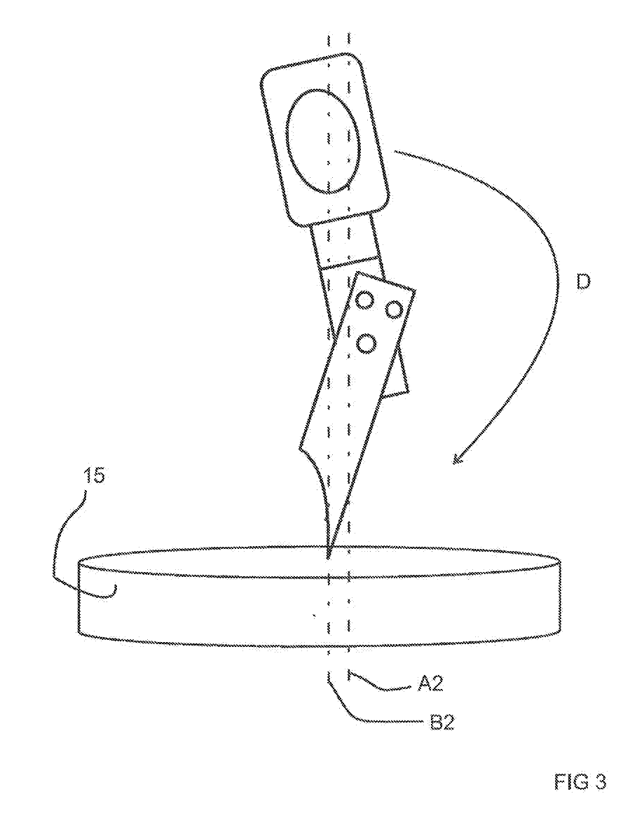

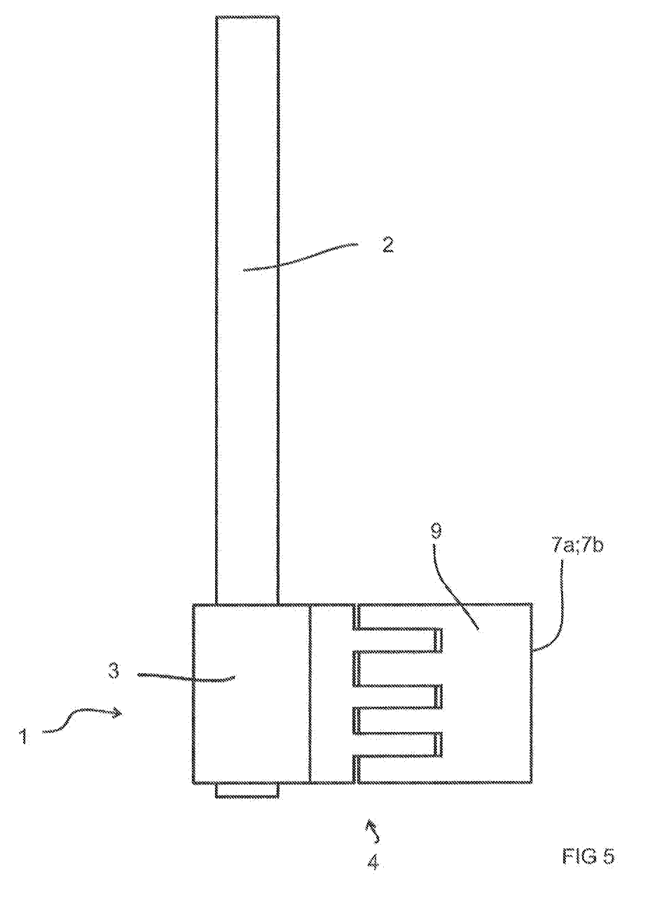

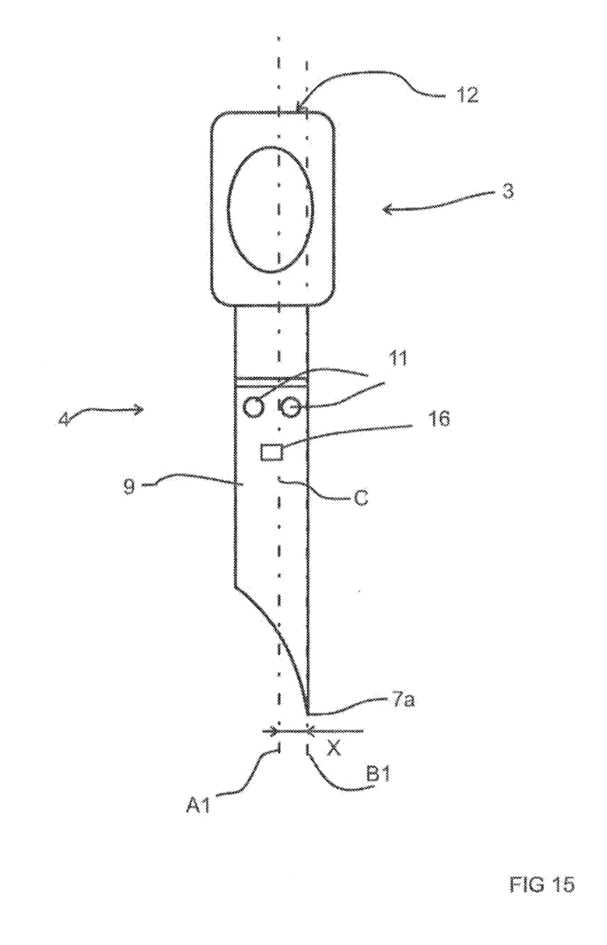

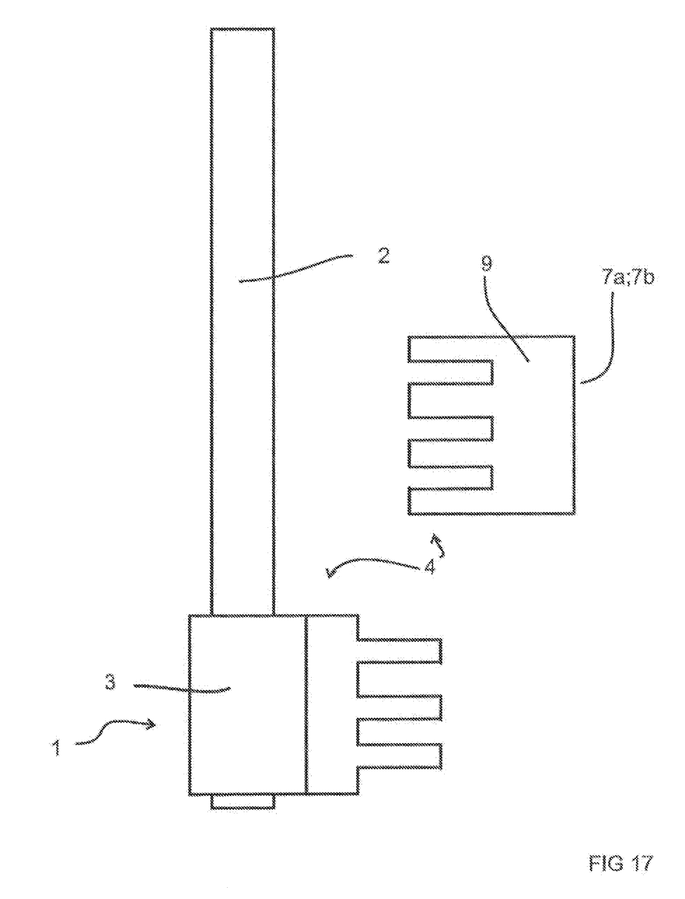

The blade means 4 can as in the first embodiment shown in FIGS. 1 to 5 and in the sixth embodiment shown in FIGS. 15 to 17, comprise a first blade member 9 configured to be arranged with respect to the handle attaching structure 3 in a first position to provide said chopping blade 5 and in a second position to provide said splitting blade 6.

FIGS. 1 to 5 shows a first embodiment of the axe.

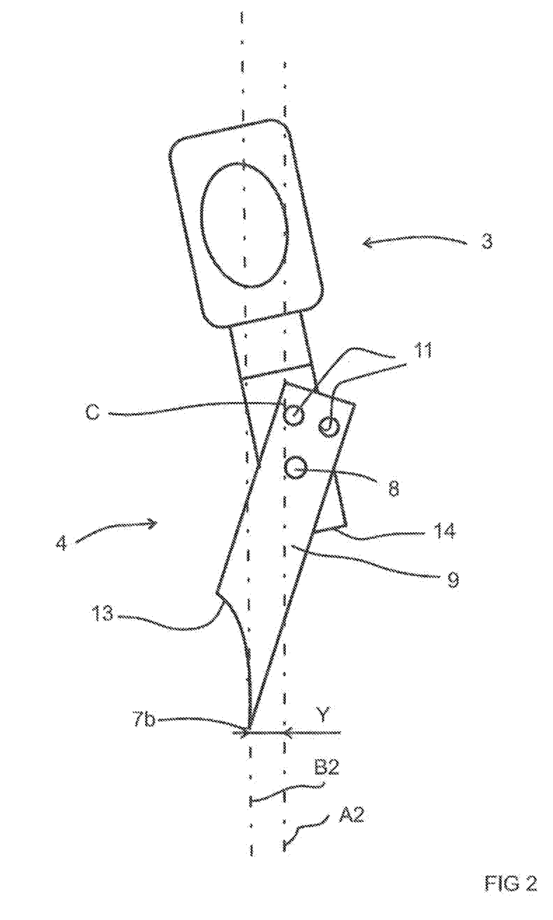

In the first embodiment of the axe, said blade means 4 comprises a first blade member 9 configured to be arranged with respect to the handle attaching structure 3 in a first position to provide said chopping blade 5 and in a second position to provide said splitting blade 6. In the first embodiment of the axe, the first blade member 9 of said blade means is pivotally connected to the handle attaching structure 3 by means of a pivot member 8 so that the first blade member 9 can pivot, i.e. be selectively pivoted, about a pivot axis Z with respect to the handle attaching structure 3 between the first position, as illustrated in FIG. 1, to provide said chopping blade 5 and the second position, as illustrated in FIG. 2, to provide said splitting blade 6. The pivot axis Z can extend in the same direction as the cutting edge 7a, 7b of the blade. In the first position, the center of gravity C of the axe head 1 is on a center-of-gravity plane marked with reference sign A1 and in the second position, the center of gravity C of the axe head 1 is on a center-of-gravity plane marked with reference sign A2. In other words, the center of gravity C of the axe head 1 moves when the first blade member 9 is pivoted with respect to the handle attaching structure 3 between the first position and the second position in an axe according to the first embodiment.

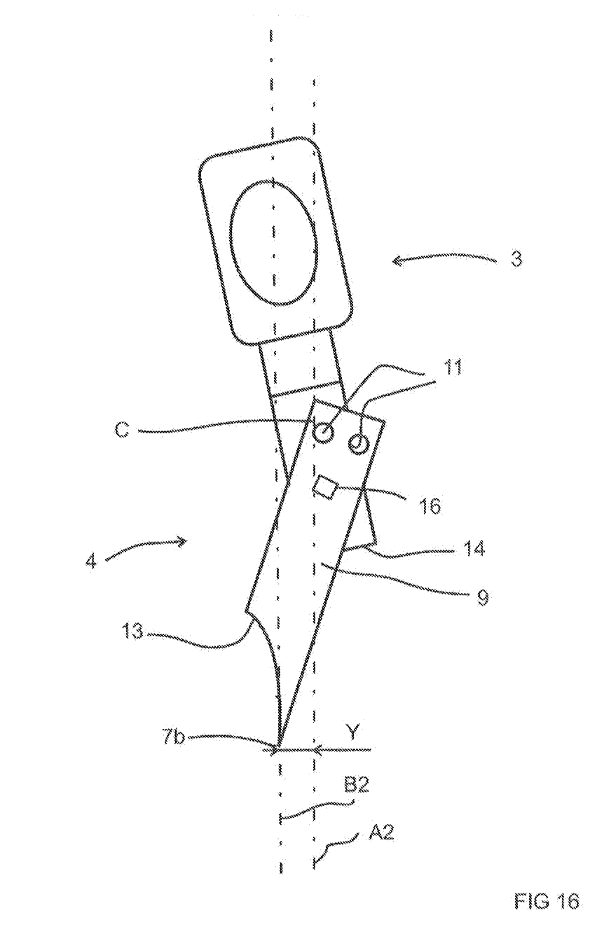

FIGS. 15 to 17 shows a sixth embodiment of the axe. In the sixth embodiment of the axe, said blade means 4 comprises a first blade member 9 configured to be arranged with respect to the handle attaching structure 3 in a first position to provide said chopping blade 5, as shown in FIG. 15, and in a second position to provide said splitting blade 6, as shown in FIG. 16. In the sixth embodiment of the axe, the first blade member 9 of said blade means 4 is releasable connected to the handle attaching structure 3 by means of an attachment member 16 so that the first blade member 9 can be attached to the handle attaching structure 3 in the first position to provide said chopping blade 5 and in the second position to provide said splitting blade 6.

In the first embodiment and in the sixth embodiment of the axe the handle attaching structure 3 forms preferably, but not necessarily, in the second position of the first blade member 9 a second stopping element 14 configured to hit the piece of wood 15 during the rotational motion of the axe head 1 and the motion of the axe head 1 in the curvilinear trajectory D. Such second stopping element 14 enhances safety of use, because the rotational motion of the axe head 1 and the motion of the axe head 1 in a curvilinear trajectory D stops, then the second stopping element 14 hits an object such as the piece of wood 15 that is split with the axe.

In the first embodiment and in the sixth embodiment of the axe the first blade member 9 comprises preferably, but not necessarily, at least one first stopping element 13 that is in the second position of the first blade member 9 configured to be located on the opposite side of the second blade plane B2 where the center of gravity C of the axe head 1 is located, wherein said at least one first stopping element 13 is located at a distance from the cutting edge 7a, 7b of the first blade member 9, and wherein said at least one first stopping element 13 is configured to prevent the first blade member 9 from penetrating too deeply into the piece of wood 15 before the rotational motion of the axe head 1 and the motion of the axe head 1 in the curvilinear trajectory D starts.

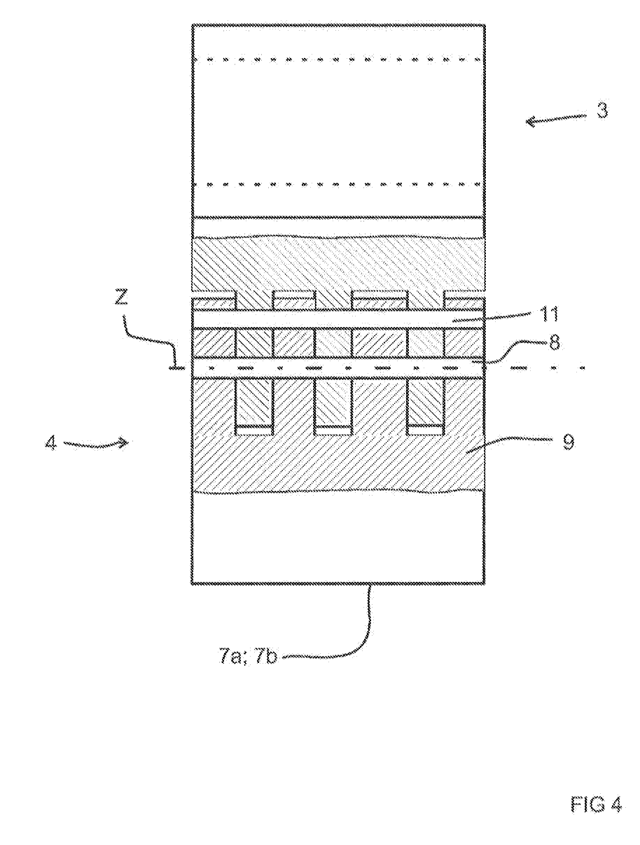

In the first embodiment and in the sixth embodiment of the axe the axe comprises preferably, but not necessarily, a locking element 11 for locking the first blade member 9 with respect to the handle attaching structure 3 in the first position and for locking the first blade member 9 with respect to the handle attaching structure 3 in the second position. The locking element 11 can comprise a pin (not marked with a reference numeral) to be placed to be simultaneously located in holes (not marked with a reference numeral) in the first blade member 9 and holes (not marked with a reference numeral) in the handle attaching structure 3 as illustrated in FIG. 4.

In the first embodiment and in the sixth embodiment of the axe the axe head 1 comprises preferably, but not necessarily, a flat surface 12 that is configured to function as a hammer head, and that is provided on the opposite side of the handle attaching structure 3 than the first blade member 9.

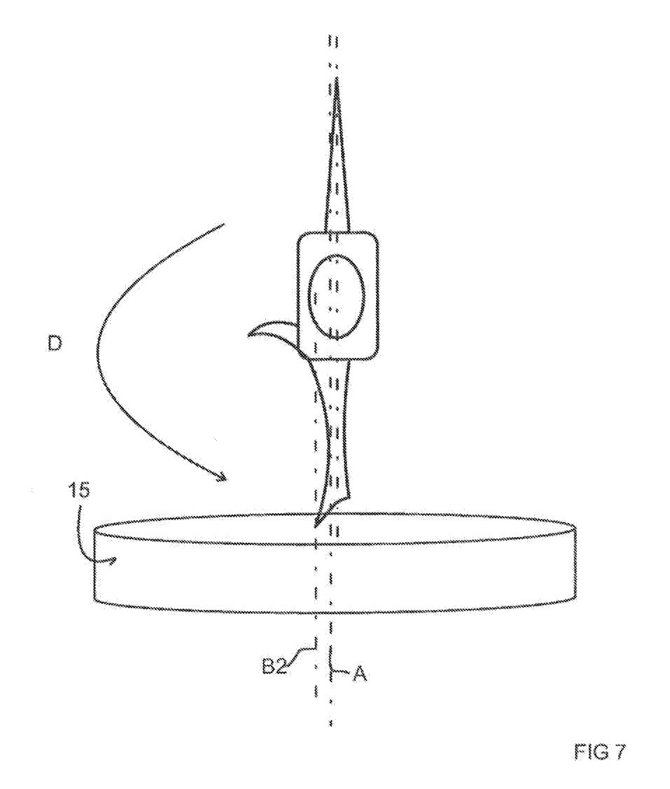

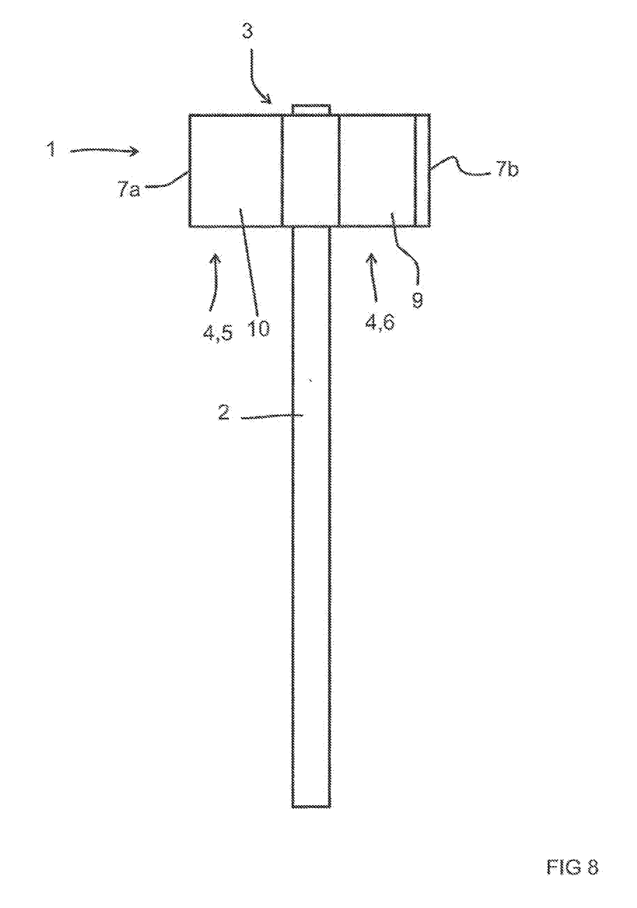

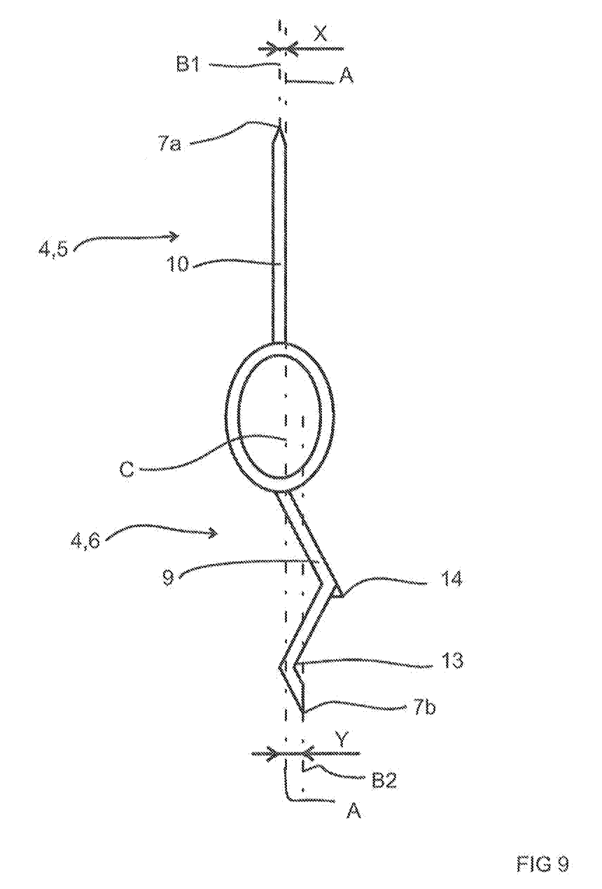

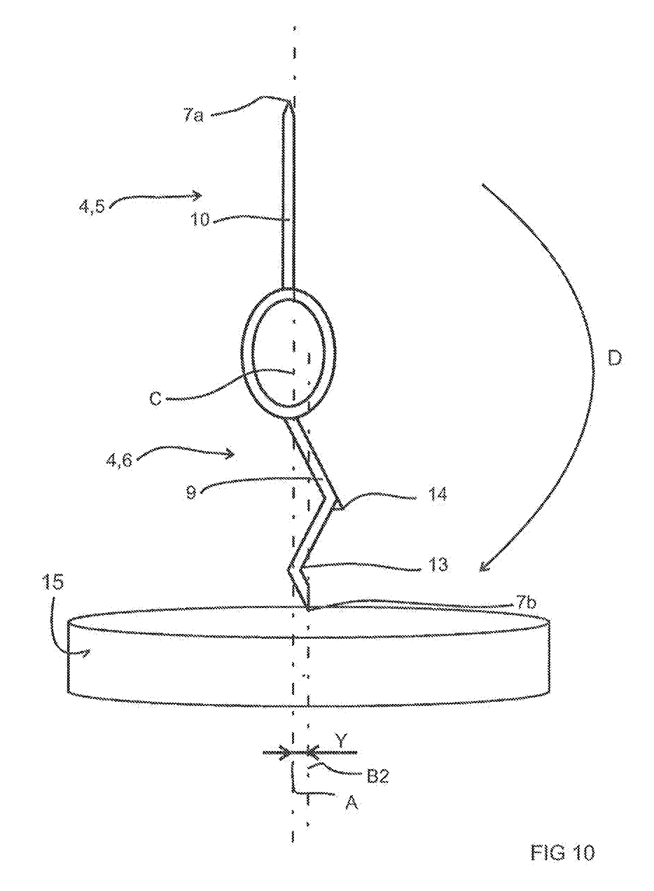

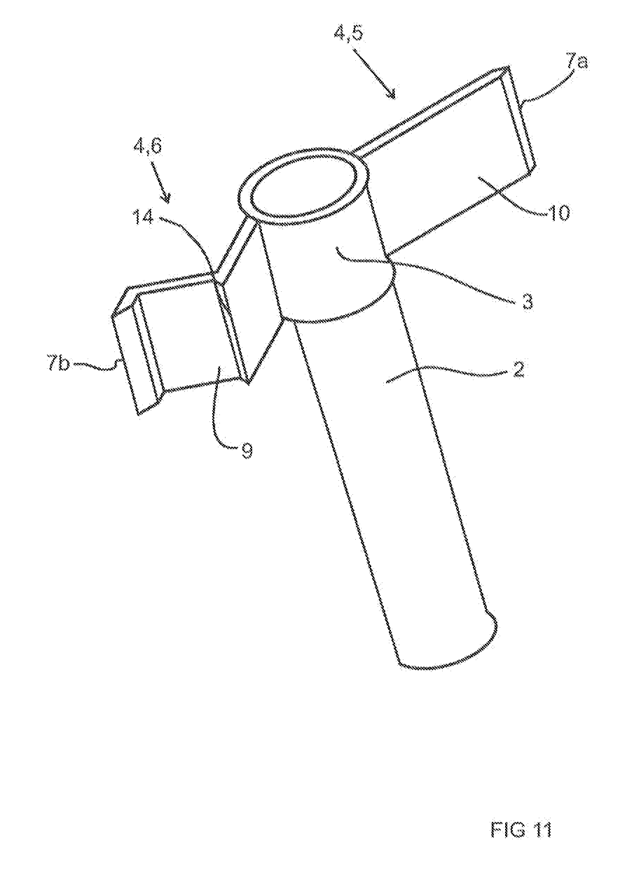

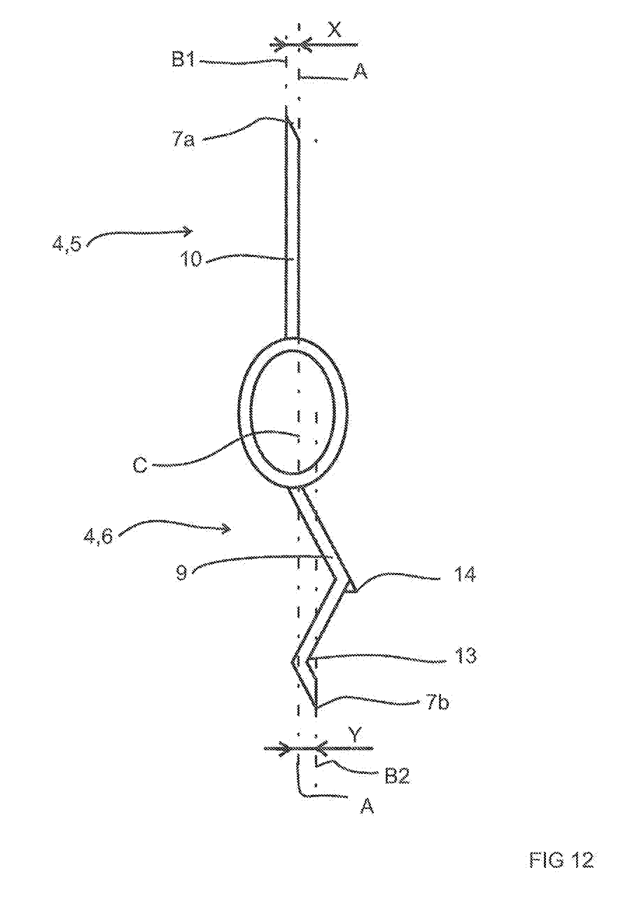

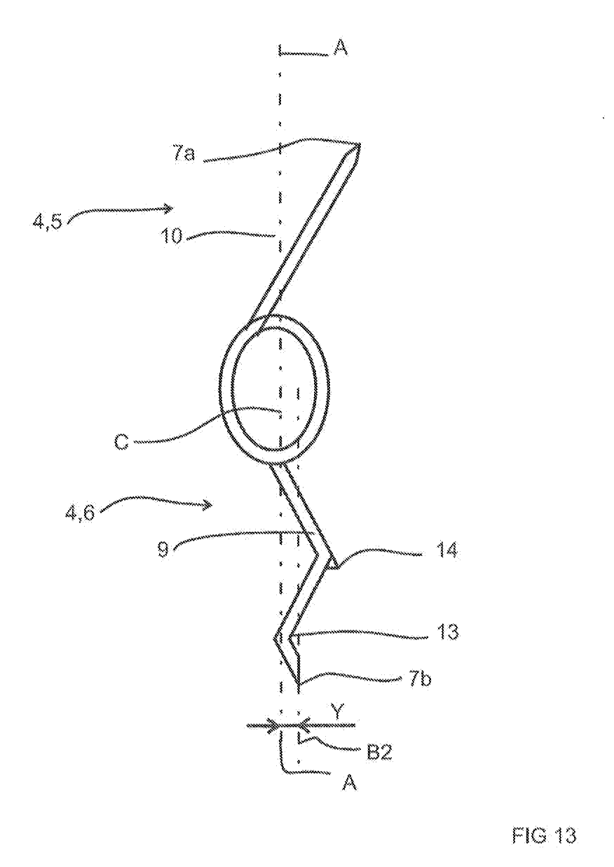

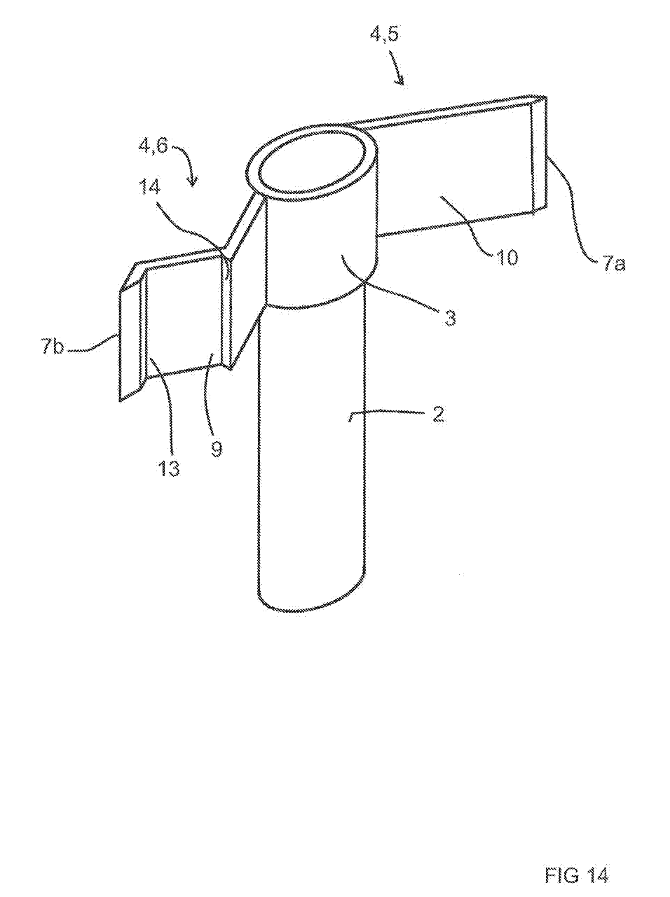

FIGS. 7 to 8 shows a second embodiment of the axe, FIGS. 9 to 11 shows a third embodiment of the axe, FIG. 12 show a fourth embodiment of the axe, and FIGS. 13 and 14 shows a fifth embodiment of the axe.

In the second, the third, the fourth and the fifth embodiment of the axe, said blade means 4 comprises a first blade member 9 configured to form the splitting blade 6 and additionally a second blade member 10 configured to form the chopping blade 5.

In the second and third embodiment of the axe, the first blade member 9 and the second blade member 10 being preferably, but not necessarily, arranged on opposite sides of the handle attaching structure 3.

In the second and third embodiment of the axe, the axe head 1 comprises preferably, but not necessarily, a second stopping element 14 configured to hit the piece of wood 15 during the rotational motion of the axe head 1 and the motion of the axe head 1 in a curvilinear trajectory D. Such second stopping element 14 enhances safety of use, because the rotational motion of the axe head 1 and the motion of the axe head 1 in a curvilinear trajectory D stops, then the second stopping element 14 hits an object such as the piece of wood 15 that is split with the axe.

In the second and third embodiment of the axe, the first blade member 9, that is configured to form the splitting clade 6 of the axe head 1, comprises preferably, but not necessarily, at least one first stopping element 13. Said at least one first stopping element 13 is located at a distance from the cutting edge 7b of the first blade member 9, and said at least one first stopping element 13 is configured to prevent the first blade member 9 from penetrating too deeply into the piece of wood 15 before the rotational motion of the axe head 1 and the motion of the axe head 1 in the curvilinear trajectory D starts.

In the third embodiment of the axe illustrated in FIGS. 9 to 11, the second blade member 10 is symmetric with respect to the first blade plane B. In the third embodiment of the axe illustrated in FIGS. 9 to 11, the second blade member 10 is additionally symmetric with respect to the center-of-gravity plane A. A purpose of this is to make the axe balanced when the axe is used as a chopping axe.

In the fourth embodiment of the axe illustrated in FIG. 12, the second blade member 10 is symmetric with respect to the first blade plane B and symmetric with respect to the center-of-gravity plane A except for the cutting edge 7a of the second blade member 10. In the fourth embodiment of the axe, the cutting edge 7a of the second blade member 10 has a face (not marked with a reference numeral) that extend in an angle between opposite side faces (not marked with a reference numeral) of the second blade member 10.

In the fifth embodiment of the axe illustrated in FIGS. 13 and 14, the second blade member 10 extend from the handle attaching structure 3 in an angle respect to the center-of-gravity plane A. A purpose of this is to make the second blade member betted suitable for whittling.

In the second, the third, the fourth, and the fifth embodiment of the axe, the axe head 1 is preferably, but not necessarily, formed at least partly of a flat blade stock of generally uniform thickness. In the second, the third, the fourth, and the fifth embodiment of the axe, the axe head 1 is preferably, but not necessarily, formed of a flat blade stock of generally uniform thickness.

In the second, the third, the fourth, and the fifth embodiment of the axe, the axe head 1 comprises preferably, but not necessarily, a flat surface 12 that is configured to function as a hammer head, and that is provided at the handle attaching structure 3.

It is apparent to a person skilled in the art that as technology advances, the basic idea of the invention can be implemented in various ways. The invention and its embodiments are therefore not restricted to the above examples, but they may vary within the scope of the claims.

1. An axe comprising:
an axe head; and
a handle to which one end portion the axe head is arranged, wherein the axe head includes a handle attaching structure, and blade means attached to the handle attaching structure, the blade means being configured to provide a chopping blade and a splitting blade;
wherein a center of gravity (C) of the axe head lies in a center-of-gravity plane (A; A1; A2) of the axe head;
wherein the chopping blade of the axe head has a cutting edge, the center-of-gravity plane (A; A1; A2) of the axe head being parallel with a first blade plane (B1) on which the cutting edge of the chopping blade of the axe head is located;
wherein the splitting blade of the axe head has a cutting edge, the center-of-gravity plane (A; A1; A2) of the axe head being parallel with a second blade plane (B2) on which the cutting edge of the splitting blade of the axe head is located;
wherein the center-of-gravity plane (A; A2) is located at a first distance (Y) from the second blade plane (B2) on which the cutting edge of the splitting blade of the axe head is located; and
wherein the cutting edge of the splitting blade of the axe head and the center of gravity (C) of the axe head are arranged to cooperate when the cutting edge of the splitting blade of the axe head hits a piece of wood and the cutting edge of the splitting blade of the axe head penetrates into the piece of wood, such that at least some of the impact force of the axe head will be converted into a rotational motion of the axe head and a motion of the axe head in a curvilinear trajectory (D).

2. The axe according to claim 1, wherein the center-of-gravity plane (A; A1) is located at a second distance (X) from the first blade plane (B1) on which the cutting edge of the chopping blade of the axe head is located, the first distance (Y) being longer than the second distance (X).

3. The axe according to claim 1 wherein said blade means comprises:
a first blade member configured to be arranged with respect to the handle attaching structure in a first position to provide said chopping blade and in a second position to provide said splitting blade.

4. The axe according to claim 3, wherein the first blade member of said blade means is pivotally connected to the handle attaching structure of a pivot member so that the first blade member will pivot about a pivot axis Z with respect to the handle attaching structure between the first position to provide said chopping blade and the second position to provide said splitting blade.

5. The axe according to claim 4, wherein the pivot axis Z extending in the same direction as the cutting edge.

6. The axe according to claim 3, wherein the first blade member of said blade means is releasably connected to the handle attaching structure by an attachment member so that the first blade member is attached to the handle attaching structure in the first position to provide said chopping blade and in the second position to provide said splitting blade.

7. The axe according to claim 3, wherein the handle attaching structure forms in the second position of the first blade member a second stopping element configured to hit the piece of wood during rotational motion of the axe head and the motion of the axe head in the curvilinear trajectory (D).

8. The axe according to claim 3, wherein the first blade member comprises:
at least one first stopping element that is in the second position of the first blade member configured to be located on the opposite side of the second blade plane (B2) where the center of gravity (C) of the axe head is located;
wherein said at least one first stopping element is located at a distance from the cutting edge of the first blade member; and
wherein said at least one first stopping element is configured to prevent the first blade member from penetrating too deeply into the piece of wood before rotational motion of the axe head and motion of the axe head in the curvilinear trajectory (D) starts.

9. The axe according to claim 3, comprising:
a locking element for locking the first blade member with respect to the handle attaching structure in the first position and for locking the first blade member with respect to the handle attaching structure in the second position.

10. The axe according to claim 3, wherein the axe head comprises:
a flat surface configured to function as a hammer head, the flat surface and the first blade member being provided on the opposite side of the handle attaching structure.

11. The axe according to claim 1, wherein the blade means comprises:
a first blade member configured to form the splitting blade; and
a second blade member configured to form the chopping blade.

12. The axe according to claim 11, wherein the first blade member and the second blade member are arranged on opposite sides of the handle attaching structure.

13. The axe according to claim 11, wherein the axe head comprises:
a second stopping element configured to hit the piece of wood during rotational motion of the axe head and motion of the axe head in a curvilinear trajectory (D).

14. The axe according claim 11, wherein the first blade member, that is configured to form the splitting blade of the axe head, comprises:
at least one first stopping element at a distance from the cutting edge of the first blade member, said at least one first stopping element being configured to prevent the first blade member from penetrating too deeply into the piece of wood before the rotational motion of the axe head and the motion of the axe head in the curvilinear trajectory (D) starts.

15. The axe according claim 11, wherein the second blade member is symmetric with respect to the first blade plane (B1).

16. The axe according claim 11, wherein the second blade member being symmetric with respect to the center-of-gravity plane (A).

17. The axe according claim 11, wherein the axe head is formed at least partly of a flat blade stock of generally uniform thickness.

18. The axe according claim 11, wherein the axe head comprises:
a flat surface configured to function as a hammer head, the flat surface is provided at the handle attaching structure.

19. The axe according to claim 1, wherein the handle is foldable and/or telescopic.

20. The axe according to claim 2, wherein said blade means comprises:
a first blade member configured to be arranged with respect to the handle attaching structure in a first position to provide said chopping blade and in a second position to provide said splitting blade.
